(19) United States
(12) Patent Application Publication
(10) Pub. No.: US 2007/0163529 A1
(43) Pub. Date: Jul. 19, 2007

(54) Wraparound drive for internal combustion engines having drive damping

(75) Inventors: Bernd Hartmann, Weisendorf (DE); Tino Haensel, Emskirchen (DE); Thomas Bertelshofer, Ebermannstadt (DE); Rainer Pflug, Heilsbronn (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/482,476

(22) Filed: Jul. 7, 2006

Related U.S. Application Data
(60) Provisional application No. 60/697,925, filed on Jul. 8, 2005.

(51) Int. Cl. F01L 1/02; F16H 7/10; F02B 77/00

(52) U.S. Cl. 123/90.27; 123/90.31; 123/195 C; 474/112

(57) ABSTRACT

Wraparound drive, in particular control drive, for an internal combustion engine, having at least one driving gearwheel and at least one driven gearwheel and a tensioning or deflecting roller and having a wraparound means (toothed belt or chain) which connects said gearwheels and rollers, wherein the driving and/or driven gearwheel is designed according to the ID² system such that, during rotation, it imparts a nonuniformity to the drive with the aim of damping the drive, wherein at least one additional auxiliary unit is also driven, characterized in that the gearwheel (6, 6′, 6″) of the auxiliary unit is connected to the driving shaft thereof by means of a non-rigid clutch.

### DESCRIPTION OF THE INVENTION

Wraparound drive for internal combustion engines having drive damping

### FIELD OF THE INVENTION

The invention relates to a wraparound drive, in particular control drive for an internal combustion engine, having at least one driving gearwheel and at least one driven gearwheel and a tensioning or deflecting roller and having a wraparound means (toothed belt or chain) which connects said gearwheels and rollers, wherein the driving and/or driven gearwheel is designed according to the ID² system such that, during rotation, it imparts a nonuniformity to the drive with the aim of damping the drive, wherein at least one additional auxiliary unit is also driven.

### BACKGROUND OF THE INVENTION

Control drives of internal combustion engines having a crankshaft driving wheel, at least one camshaft driven wheel and a chain or a toothed belt or else other assembly drives which are present on internal combustion engines are subject to vibrational changes as a result of torque fluctuations and/or angular speed changes, which vibrational changes can lead to audible noise in resonant ranges. Associated with this are increased frictional forces which can adversely affect the service life and the efficiency of a wraparound drive.

A variety of measures for countering said problems have already been proposed. DE 195 20 508 A1 discloses a wraparound drive having a means which imparts an additional nonuniformity to the wraparound drive. Said nonuniformity can be generated by means of a wheel which is non-circular and/or is mounted eccentrically. Said artificially generated nonuniformities are intended to counteract the vibrational changes which are produced by combustion processes and valve movements.

In one of the most frequently used damping devices, such as, for example, in the ID² system, the driving and driven gearwheels are non-circular, so that during rotation they impart a nonuniformity to the drive, said nonuniformity counteracting the nonuniformity intrinsic in the system. While a normal control drive having a crankshaft driving wheel and camshaft driven wheels and a free-running tensioning wheel can be drive-damped very well in this way, it becomes very difficult if one or even more auxiliary units are additionally to be driven concomitantly, since the drive-damping measures which can in principle also be applied in the same way to the gearwheels of said auxiliary units, such as a non-circular shape, can no longer be practically controlled as a result of the superposition of the many force signals of n-th order.

### SUMMARY OF THE INVENTION

The invention is therefore based on the object of designing a wraparound drive of the type mentioned in the introduction with additionally driving auxiliary units such that the vibration-damping devices at the driving and driven wheels of the normal drive are adversely affected as little as possible by the auxiliary units.

According to the invention, to achieve said object, it is provided that the gearwheel of the auxiliary unit is connected to the driving shaft thereof by means of a non-rigid clutch, so that torque fluctuations as a result of different loads in the auxiliary unit cannot be fully transmitted through to the traction means.

According to a first exemplary embodiment of the present invention, it can be provided for this purpose that an overrunning clutch is provided on the auxiliary unit.

If, during the course of the substantially sinusoidal movement, the shaft is faster than the driving wheel, decoupling takes place, as a result of which the shaft need not always be braked to as great a degree as the driving wheel, and this in turn leads to reduced feedback to the wraparound drive, and therefore to reduced vibrations.

According to a second embodiment of the present invention, it can be provided that the driving wheel of the auxiliary unit is embodied as an absorber, with the transmission of vibrations between the outer wheel, which is driven by the wraparound means, and the inner wheel, which is connected to the shaft, being damped by means of an elastomer being positioned in between.

In a third embodiment of the invention, it is finally provided that the driving wheel of the auxiliary unit is embodied as a dual-mass flywheel, wherein the resonant speed of the dual-mass flywheel is preferably below the idling speed of the engine.

### BRIEF DESCRIPTION OF THE DRAWINGS

Further advantages, features and details of the invention can be gathered from the following description of an exemplary embodiment and on the basis of the drawing, in which:

FIG. 1 shows a schematic view of a control drive in an internal combustion engine, by means of which an auxiliary unit is driven concomitantly,

FIG. 2 shows a cut-away illustration of the driving wheel, which is formed as an absorber, of the auxiliary unit,

FIG. 3 shows a partial section through the auxiliary unit having an overrunning clutch installed in its driving wheel and

FIGS. 4a and 4b show a schematic view of a driving wheel, which is embodied as a dual-mass flywheel, for the auxiliary unit, in different operating states.

### DETAILED DESCRIPTION OF THE DRAWINGS

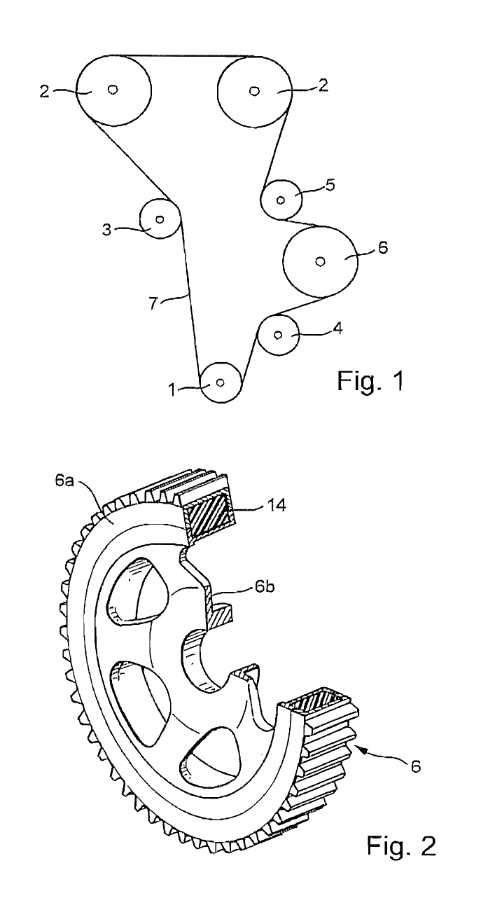

FIG. 1 shows the control drive of the internal combustion engine having the crankshaft driving wheel 1, two camshaft driven wheels 2, a plurality of free-running tensioning or deflecting rollers 3, 4 and 5 and the driving wheel 6 of an auxiliary unit, for example a high-pressure fuel pump, with said wheels all being connected by a wraparound drive 7, preferably a toothed belt or a chain.

The driving and driven wheels 1 and 2 are designed in the way known, for example, from the ID² system, for the purpose of drive damping, and are for example non-circular, with the spacing being coordinated with the number of cylinders of the engine.

In order that the drive damping which is achieved in this way is not disrupted by the auxiliary unit, the driving gearwheel 6 thereof can, as illustrated in FIG. 2, be embodied as an absorber. For this purpose, the driving wheel 6 is divided into an outer ring 6a which meshes with the wraparound means 7 and an inner part 6b which is fixedly connected to the driving shaft of the auxiliary unit, with the transmission of vibrations being damped by means of an elastomer 14 being positioned in between.

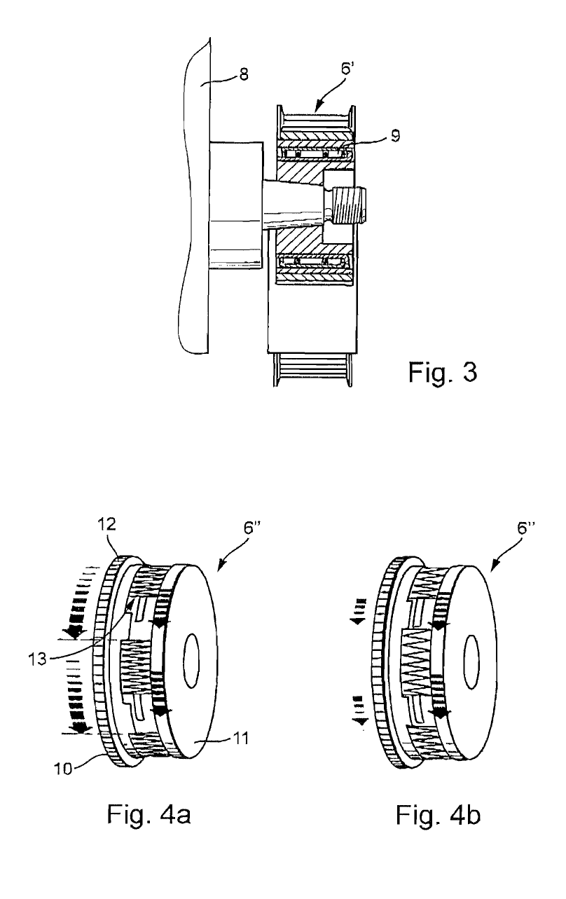

FIG. 3 schematically shows a driving gearwheel 6′ for an auxiliary unit 8, for example a high-pressure pump, wherein an overrunning clutch 9 is installed in said driving gearwheel 6′.

FIGS. 4a and 4b show a further design option for the driving gearwheel 6″ of the auxiliary unit, wherein in this case the driving gearwheel 6′ is embodied as a dual-mass flywheel. Here, the driving gearwheel 6″ is divided into two parts 10 and 11, of which the part 10 has the outer toothing 12 for the wraparound drive, while the second part 11, which is fixedly connected to the shaft of the auxiliary unit, is connected to the first part 10 by means of a spring/damper system 13. In the event of fluctuating load, said fluctuations are partially absorbed by the spring/damper system 13, and drive damping is thus obtained. Here, through suitable design of the dual-mass flywheel, the resonant speed can be reduced below the idling speed.

### REFERENCE NUMBERS

1 Crankshaft driving wheel
2 Camshaft driven wheels
3 Tensioning or deflecting roller
4 Tensioning or deflecting roller
5 Tensioning or deflecting roller
6 Driving wheel
6′ Driving gearwheel
6″ Driving gearwheel
6a Outer ring
7 Wraparound drive
8 Auxiliary unit
9 Overrunning clutch
10 Driving wheel, first part
11 Driving wheel, second part
12 Outer toothing
13 Spring/damper system
14 Elastomer

1. A wraparound drive for an internal combustion engine, comprising at least one driving gearwheel; at least one driven gearwheel; a tensioning or deflecting roller; a wraparound means which connects said gearwheel and roller;
wherein the driving and/or driven gearwheel is designed according to the ID² system such that, during rotation, it imparts a nonuniformity to the drive with the aim of damping the drive;
wherein at least one additional auxiliary unit is also driven; and, wherein the gearwheel of the auxiliary unit is connected to the driving shaft thereof by means of a non-rigid clutch.

2. The drive according to claim 1, wherein an overrunning clutch is installed in the driving wheel of the auxiliary unit.

3. The drive according to claim 1, wherein the driving wheel (6) of the auxiliary unit is embodied as an absorber.

4. The drive according to claim 1, wherein the driving wheel of the auxiliary unit is embodied as a dual-mass flywheel.

5. The drive according to claim 4, wherein the dual-mass flywheel is set such that the resonant speed is below the idling speed of the engine.
